(19) United States
(12) Patent Application Publication
(10) Pub. No.: US 2024/0227640 A9
(43) Pub. Date: Jul. 11, 2024

(54) VEHICLE SEAT AND ASSEMBLY METHOD

(71) Applicant: Brose Fahrzeugteile SE & Co. Kommanditgesellschaft, Coburg, Coburg (DE)

(72) Inventors: Peter MÜLLER, El Marques, Queretero (MX); Donaldo MADRID, El Marques, Queretero (MX); Heiko RÖNSCH, El Marques, Queretero (MX)

(21) Appl. No.: 18/547,118

(22) PCT Filed: Jul. 1, 2021
(86) PCT No.: PCT/EP2021/068222

§ 371 Date: Aug. 18, 2023

(30) Foreign Application Priority Data
Feb. 18, 2021 (DE) 20 2021 103 609.5

(51) Int. Cl. B60N 2/30; B60N 2/08; B60N 2/20

(52) U.S. Cl. CPC B60N 2/3031; B60N 2/08; B60N 2/20; B60N 2/3065

(57) ABSTRACT

It is provided a vehicle seat comprising a seat base, a seat part which is arranged on the seat base and can be adjusted relative to the seat base, a backrest which is mounted on the seat base so as to be pivotable between an upright use position and a non-use position which is pivoted towards the seat part, and a coupling mechanism for coupling an adjustment movement of the seat part to a pivot movement of the backrest. In this case, a locking lever is provided which can be pivoted between a locking position and an unlocking position by means of the coupling mechanism, is in its locking position in the use position of the backrest and locks the backrest from pivoting into the non-use position, and can be pivoted from its locking position into its unlocking position.

### BACKGROUND

The proposed solution relates to a vehicle seat and to an assembly method for a vehicle seat.

Such a vehicle seat comprises at least a seat base, a seat part which is arranged on the seat base and can be adjusted relative to the seat base, and a backrest which is mounted on the seat base so as to be pivotable between an upright use position and a non-use position which is pivoted towards the seat part. Furthermore, such a vehicle seat also comprises a coupling mechanism for coupling an adjustment movement of the seat part to a pivot movement of the backrest.

Vehicle seats with pivotably mounted backrests as well as assembly methods for assembling a vehicle seat with a pivotable backrest are known in principle from the field of vehicle manufacturing.

In this case, pivoting the backrest into the non-use position serves in particular to reduce the space occupied by the vehicle seat mounted in a vehicle. By contrast, pivoting the backrest into the use position serves in particular to provide a seat surface together with backrest for a vehicle seat user.

As a result of the pivotable mounting of the backrest on the seat base, the backrest can be pivoted between the use position and non-use positions by the introduction of an adjustment force. The adjustment force can be initiated here not only by an intentional action of a vehicle seat user but also by unintentional actions. Furthermore, forces acting as an adjustment force can also be caused by a slipping load, especially in the event of an accident.

It should be possible to avoid unintentional pivoting, in particular from the use position to the non-use position, both for reasons of user comfort and for reasons of safety. For efficient assembly, it is also of interest that any solution for avoiding unintentional pivoting does not disproportionately increase the assembly effort for the vehicle seat.

### SUMMARY

Against this background, the object is to provide an improved vehicle seat with a pivotable backrest and an improved assembly method for a vehicle seat with a pivotable backrest.

This object is achieved by a vehicle seat having features as described herein and by an assembly method having features as described herein.

Accordingly, in the vehicle seat according to the proposed solution, a locking lever is provided which can be pivoted between a locking position and an unlocking position by means of the coupling mechanism, is in its locking position in the use position of the backrest and locks the backrest from pivoting into the non-use position, and can be pivoted from its locking position into its unlocking position for pivoting the backrest from the use position into the non-use position.

The introduction of a force into the backrest fixed via the locking lever can thus no longer lead to a pivoting of the backrest between the use position and non-use position. As a result, the backrest can be locked in particular against unintentional pivoting, for example by a person leaning on the backrest, by a slipping load or in the event of an accident. In particular with regard to the use of the proposed vehicle seat as a vehicle seat for a vehicle driver, a distraction or disturbance caused by an unintentional pivoting of the backrest can thus be prevented. This may also reduce the risk of an accident caused by the driver due to distraction or disturbance.

The pivotable mounting of the backrest on the seat base may define a backrest pivot axis. By pivoting the backrest about the backrest pivot axis, portions of the backrest may also be pivotable about the backrest pivot axis. As an example, the portions can move on a circular-arc-shaped trajectory curve around the backrest pivot axis. In principle, neither the shape of the trajectory curve nor its relative position with respect to the pivot axis is fixed to a circular-arc-shaped movement about the backrest pivot axis.

By fixing at least one backrest portion in a fixed position on its trajectory curve, the backrest can also be locked against pivoting between the non-use position and use position. Such a fixing of a backrest portion can be realized here according to the proposed solution by the locking lever in the locking position.

In one embodiment of the proposed solution, the locking lever can be pivoted on the backrest between the locking position and the unlocking position by means of the coupling mechanism. In this case, the locking lever can rest against a portion of the seat base in the locking position and can be pivoted from its locking position into its unlocking position for pivoting the backrest from the use position into the non-use position.

In an alternative embodiment, the locking lever may be mounted on the seat base so as to be pivotable by means of the coupling mechanism between the locking position and the unlocking position. In this case, the locking lever can rest against a backrest portion in the locking position and can be pivoted from its locking position into its unlocking position for pivoting the backrest from the use position into the non-use position.

In particular, the locking lever can be rest against the backrest portion in such a way that movement of the backrest portion along its trajectory curve can be prevented. The portion can thus be fixed and the backrest can be locked from pivoting between the use position and the non-use position.

To release the fixing of the backrest portion, the locking lever can be pivoted from the locking position into the unlocking position. In the unlocking position, the locking lever may not be in contact with a backrest portion or not in contact therewith in such a way that the backrest can be blocked from pivoting between the use position and the non-use position.

Via the mounting of the backrest on the seat base, the backrest is pivotable in at least two pivot directions. The same can also apply to a backrest portion. Thus, in general, the portion provided for locking the pivotability of the backrest can also be pivotable in a plurality of pivot directions.

The embodiments described below are limited to those in which the locking lever is pivotably mounted on the seat base. In principle, however, a pivotable mounting of the locking lever on the backrest is also conceivable in the embodiments described below.

In one embodiment of the proposed solution, the locking lever can be in contact with the backrest portion provided for locking the pivotability of the backrest in such a way that the portion can be fixed against each of the pivot directions of the portion predetermined by the mounting of the backrest on the seat base.

In an alternative embodiment, the backrest portion provided for locking the pivotability of the backrest can be fixed via the locking lever with regard to a part of the possible pivot directions. In particular, the backrest portion can be fixed via the locking lever with regard to exactly one possible pivot direction. By way of example, the one pivot direction of the backrest portion that can be fixed in the locking position by the locking lever can be the pivot direction in which the backrest portion is pivotable when the backrest is pivoted from the use position into the non-use position.

In a supplementary embodiment, the vehicle seat can have a further element by means of which the backrest portion provided for locking the pivotability of the backrest can be fixed with regard to the remaining pivot direction. For example, the remaining pivot direction can be the pivot direction in which the backrest portion can be pivoted when the backrest is pivoted from the non-use position into the use position.

In order to define a specific use position, the backrest portion intended to lock the pivotability of the backrest can be fixed without play.

In addition, the vehicle seat according to the proposed solution can in principle have a spring element with which the locking lever is pre-tensioned in the direction of the unlocking position.

Such a spring element can be an elastic element here, which is connected to the locking lever and another portion of the vehicle seat and applies a pre-tensioning force to the locking lever so that the locking lever can only be deflected from the unlocking position against the pre-tensioning force.

The spring element allows the locking lever to be pivoted back and forth between the locking position and the unlocking position, wherein an adjustment force only has to be applied for pivoting from the unlocking position into the locking position. A return from the locking position to the unlocking position can be effected by the pre-tension. This can also reduce the adjustment effort for the locking lever.

In a further embodiment of the vehicle seat according to the proposed solution, the coupling mechanism for pivoting the locking lever from the unlocking position into the locking position may comprise an unlocking element which is adjustably mounted on the seat base and/or the backrest.

Via the coupling mechanism, the unlocking element can be displaced under the effect of the adjustment movement of the seat part. Thus, the locking lever can also be pivotable between the unlocking position and the locking position by the unlocking element under the effect of the adjustment movement of the seat part.

In one embodiment, the unlocking element can apply a deflection force to the locking lever by displacing it against the pre-tension applied by the spring element. The deflection force can be used to cause the locking lever to pivot from the unlocking position to the locking position.

In a further embodiment, the unlocking element may have a coupling portion. The coupling portion can be operatively connected to the locking lever at least in the locking position. By way of example, such a coupling portion can be designed as a projection. The deflection force can be introduced into the locking lever via the coupling portion by displacing the unlocking element.

In a further embodiment, the unlocking element can be formed with two coupling portions. Both coupling portions can each be formed as a projection on the unlocking element. One of the two coupling portions can be operatively connected to the locking lever at least in the locking position and the other of the two coupling portions can be operatively connected to the locking lever at least in the unlocking position.

The unlocking element can be configured to pivot the locking lever via the two coupling elements by moving the unlocking element between the locking position and the unlocking position.

By way of example, the two coupling elements can be designed as drivers. By moving the unlocking element, depending on the direction of movement of the unlocking element, one of the coupling elements can drive a portion of the locking lever and thus cause the locking lever to pivot from the locking position into the unlocking position, or vice versa. The portion of the locking lever can be designed as a pin for this purpose.

In an alternative embodiment, the coupling portion may be hingedly connected to the locking lever. In a further alternative embodiment, both the locking lever and the unlocking element can have toothed portions. The toothed portion of the locking lever can engage here in the toothed portion of the unlocking element. In addition, other operative connections between the unlocking element and the locking lever are also conceivable in principle, as long as the locking lever can be pivoted from the unlocking position into the locking position by moving the unlocking element that is operatively connected to the locking lever.

The backrest portion intended to lock the pivotability of the backrest can be fixed without play via the operative connection between the unlocking element and the locking lever.

In a further embodiment of the vehicle seat according to the proposed solution, the seat base may comprise a guide for guiding the backrest when pivoting between the use position and the non-use position.

By guiding the backrest during the pivot movement in a guide, the degrees of freedom of movement of the backrest can be restricted. Thus, the system can be stiffened, especially against forces that are directed differently than an intended adjustment force. In the following, such forces are summarized under the term “misalignment forces”. This can increase the deformation stability of the vehicle seat in the event of an accident and thus improve the safety of the vehicle seat user.

In an alternative or supplementary embodiment of the proposed vehicle seat, there may be arranged on the backrest a guide element, which can be guided along the guide when the backrest is pivoted from the use position into the non-use position.

By way of example, such a guide can be formed with a guide slot.

By pivoting the backrest about the backrest pivot axis, the guide element can be pivoted along a trajectory curve. In one embodiment of the proposed solution, the guide slot can correspond here to the trajectory curve of the guide element.

The guide element of the backrest can furthermore rest on a rim of the guide slot, by way of example. Such a rim can run parallel to the trajectory curve of the guide element. A backrest that is loaded by misalignment forces can thus be configured to introduce at least parts of the misalignment forces into the seat base via the guide element resting against the edge of the guide slot.

In a further embodiment of the proposed solution, the guide element may rest against a first portion of the guide slot in the use position of the backrest and against a second end portion of the guide slot in the non-use position of the backrest.

Both the first end portion and the second end portion of the guide slot can be arranged orthogonally with respect to the trajectory curve of the guide element.

The first end portion of the guide slot can be shaped in such a way that a pivoting of the backrest along the pivot direction from the non-use position into the use position beyond the use position can be blocked. Thus, due to the design of the guide slot, a pivoting of the backrest into the use position in one of two possible pivot directions can be lockable. By pivoting the locking lever between the unlocking position and the locking position, the remaining pivot direction of the backrest in the use position can also be locked. Thus, depending on the position of the locking lever, the backrest in the use position can be selectively pivotable or non-pivotable in the direction of the non-use position.

Furthermore, the second end portion of the guide slot can be shaped in such a way that a pivoting of the backrest along the pivot direction from the use position into the non-use position beyond the non-use position can be blocked. The use position and the non-use position of the backrest can thus be defined by the guide rail.

In one embodiment of the proposed solution, the locking lever for locking the backrest in the locking position can rest against the guide element.

In particular, the locking lever can rest against the guide element in such a way that a movement of the guide element on its trajectory curve can be blocked. Thus, the guide element can be fixed via the locking lever. In particular, the pivoting of the backrest between the use position and the non-use position can also be lockable via the locking lever.

In a further embodiment of the vehicle seat according to the proposed solution, the seat part may be rotationally adjustably mounted on the seat base relative to the seat base.

In a further alternative or supplementary embodiment of the seat part, the seat part can be translationally adjustable relative to the seat base.

In one embodiment, the seat part can also be adjustable between a non-use position and a use position. By way of example, in the use position, the seat part can provide a seat surface for the vehicle seat user in the intended assembled state. Additionally, in the non-use position, the seat part may reduce the space occupied by the vehicle seat in the vehicle. By way of example, the seat part can be adjustable in the direction of the vehicle floor when the vehicle seat is adjusted from the use position into the non-use position of the seat part in the intended assembled state.

Thus, the loading space provided in the interior of the vehicle with the vehicle seat assembled as intended can be enlarged by the translational adjustability of the seat part. In addition, it can be easier to get in and out of the vehicle.

In an alternative or supplementary embodiment, an inclination of the seat part relative to the backrest can be adjustable. The inclination of the seat part can be adjustable to a user-specific comfort position in the use position of the backrest. Alternatively or additionally, the inclination of the seat part can also be adjustable in the non-use position of the backrest.

In a further embodiment of the vehicle seat, the seat part may be rotationally adjustable about a seat part pivot axis which is parallel to a backrest pivot axis about which the backrest is pivotable from the use position into the non-use position.

In a supplementary or alternative embodiment, the seat part may comprise a seat part lever. The seat part lever may be pivotably mounted to both the seat part and the seat base. In one embodiment, the seat part pivot axis may extend through the mounting of the seat part lever on the seat base.

In an alternative or supplementary embodiment, the vehicle seat may comprise an energy storage device. Such an energy storage device can be configured to cause a restoring force opposite the introduced force in response to a force introduced into the energy store. The introduced force can, for example, cause a compression or an expansion of the energy storage device.

By way of example, such an energy storage device can be connected to the seat part lever above or below the mounting of the seat part lever in order to introduce the restoring force into the seat part lever in response to a pivoting of the seat part lever from a predetermined neutral position of the seat part lever. In particular, the seat part lever can be pre-tensioned by the energy storage device in one of the possible pivot directions of the seat part lever.

In principle, the seat part can also have a plurality of seat part levers.

In a further embodiment, the coupling mechanism for coupling the adjustment movement of the seat part with the pivoting of the backrest may comprise a coupling element via which the adjustment movement of the seat part can be transferred to the backrest.

By means of the coupling element, it is possible to effect an adjustment of the seat part from the non-use position into the use position of the seat part by pivoting the backrest from the non-use position into the use position.

In an alternative or supplementary embodiment, the coupling element can also be used to pivot the backrest from the non-use position into the use position via the adjustment of the seat part from the non-use position to the use position.

The number of adjustment actions required to transfer the vehicle seat from the use position into the non-use position can thus be reduced. This can increase the comfort of use of the vehicle seat.

In one embodiment, the coupling element can be pivoted about a first coupling pivot axis on the backrest and about a second coupling pivot axis on the seat part. By way of example, the first coupling pivot axis can run parallel to the second coupling element pivot axis. In a further embodiment, the first coupling element pivot axis and/or the second coupling element pivot axis can run parallel to the backrest pivot axis and/or the seat part pivot axis.

In an exemplary embodiment, the coupling element can also be formed with a lever. In another exemplary embodiment, the coupling element can be formed with a toggle joint. In principle, a vehicle seat of the proposed solution can also have a plurality of coupling elements.

In a further embodiment of the solution, the seat part may comprise a sliding element and the seat base may comprise a rail, and the sliding element may be slidably mounted on the rail.

The sliding element may be translationally displaceable on the rail relative to the seat part. In particular, the sliding element may be translationally displaceable on the rail relative to the seat part by moving the seat part from the non-use position into the use position.

In a supplementary or alternative embodiment, the coupling element can be pivotably mounted on the sliding element. The coupling element can thus be translationally displaceable relative to the seat part via the sliding element.

In one embodiment, the coupling element can be translationally adjustable relative to the seat part by adjusting the seat part between the non-use position and the use position. By way of example, the backrest can be pivoted between the use position and the non-use position by translational displacement of the coupling element.

In a further embodiment of the proposed solution, the unlocking element of the coupling mechanism can be arranged on the sliding element. The unlocking element can thus be translationally displaceable relative to the seat part via the sliding element. In particular, the unlocking element can be translationally displaceable relative to the seat part via an adjustment of the seat part between the non-use position and the use position.

Adjusting the unlocking element relative to the seat part can cause the locking lever to pivot between the locking position and the unlocking position. Thus, the locking lever may be pivotable between the locking position and the unlocking position of the locking lever via adjustment of the seat part between the non-use position and use position of the seat part. In particular, the pivoting of the locking lever can take place against the pre-tension.

Thus, the coupling mechanism for pivoting the locking lever from the unlocking position into the locking position and/or from the locking position into the unlocking position may comprise an unlocking element which is slidably mounted on the seat base and/or on the backrest and which adjusts the locking lever by way of a displacement.

In an alternative or supplementary embodiment, in order to connect the unlocking element to the sliding element, the unlocking element and the sliding element can each have an opening through which a fastening part can extend.

In principle, the unlocking element can be detachably connected to the sliding element. A choice of a mounting position can thus be corrected. By way of example, a detachable connection can be formed with a screw.

In a further embodiment, to define a plurality of possible mounting positions, at least one of the openings in the unlocking element or the sliding element may be a slot.

The at least one slot can have an extent in at least one direction that is greater than a diameter of the fastening part.

The operative connection between the unlocking element and the locking lever can be adjustable by selecting the mounting position. In particular, the backrest portion intended to lock the pivotability of the backrest can be fixed without play by selecting the mounting position.

In a further embodiment of the solution, the unlocking element and/or the sliding element may comprise at least one anti-rotation device to block the unlocking element from rotation relative to the fastening part.

By way of example, an anti-rotation device with a projection may be formed on the unlocking element and/or the sliding element, wherein the projection engages in the opening of the respective other of the unlocking element and the sliding element. In a further embodiment, the at least one anti-rotation device can also engage in a further recess in the respective other of the unlocking element and the sliding element.

In principle, the pivoting of the backrest, the pivoting of the seat part or the coupled pivoting of the backrest and the seat part can be power-operated. In an exemplary embodiment, the sliding element can be moved here along the rail by a motor via a linear drive.

In addition, the proposed solution also comprises an assembly method.

The proposed assembly method for a vehicle seat comprises providing a seat base having a backrest mounted on the seat base so as to be pivotable between an upright use position and a non-use position, and an adjustable seat part, wherein a coupling mechanism is provided for coupling an adjustment movement of the seat part to a pivot movement of the backrest. Furthermore, the proposed assembly method comprises temporarily fixing a locking lever pivotably mounted on the seat base or the backrest in a fixing position, wherein the locking lever is pivotable between a locking position and an unlocking position in the assembled state of the vehicle seat, and wherein the locking lever in its locking position locks the backrest present in an upright use position on the vehicle seat from pivoting into a non-use position, and, for pivoting the backrest from the use position into the non-use position, is pivotable from its locking position into its unlocking position by means of an unlocking element of the coupling mechanism. Furthermore, the proposed assembly method also comprises a mounting of the unlocking element relative to the locking lever while the locking lever is temporarily fixed in the fixing position, and releasing the temporary fixing of the locking lever so that the locking lever is pivotable between its locking position and its unlocking position.

The proposed assembly method allows assembly of a vehicle seat whose backrest can be pivoted between the use position and the non-use position in the assembled state, provided that the locking lever is arranged in its unlocking position.

However, a pivotability of the backrest can make precise positioning of the components of the vehicle seat difficult. By releasably fixing the locking lever in the fixing position, the pivotability of the assembled backrest is locked. This can facilitate the assembly of the vehicle seat.

By way of example, the locking lever can be pivotably mounted on the seat base or on the backrest and can be releasably fixed in its fixing position.

By way of further example, the fixing position of the locking lever can correspond to the locking position of the locking lever.

A releasable fixing element can be used to temporarily fix the locking lever and is removed after the unlocking element has been assembled.

In one embodiment, a fixing opening in the locking lever can be aligned with a fixing opening in the seat base to fix the locking lever in the fixing position. By inserting the fixing element into the aligned fixing openings, the locking lever can thus be fixed releasably.

After assembly, the fixing element can be removed. By removing the fixing element, the fixing of the locking lever in the fixed position can be released. Thus, the locking lever can be pivoted between the locking position and the unlocking position by removing the fixing element.

For example, a bolt can be inserted into the aligned fixing openings for releasable fixing.

Via the coupling mechanism, the unlocking element can be displaced under the effect of the adjustment movement of the seat part. Thus, the locking lever can also be pivoted between the unlocking position and the locking position by the unlocking element under the effect of the adjustment movement of the seat part.

In one embodiment, the unlocking element may have a coupling portion. The coupling portion can be operatively connected to the locking lever at least in the locking position. By way of example, such a coupling portion can be designed as a projection. The deflection force can be introduced into the locking lever via the coupling portion by displacing the unlocking element.

The mounted locking lever can be subjected to permanently acting forces which define a neutral position to which the locking lever returns after each deflection. By way of example, such permanently acting forces can be the weight force of the locking lever. In alternative embodiments of the vehicle seat, the neutral position can also be defined by a spring element. In this case, the neutral position may also be dependent on the arrangement of the locking lever on the seat base or on the backrest. In some embodiments, the neutral position may correspond to the locking position of the locking lever. In other embodiments, the neutral position may correspond to the unlocking position of the locking lever.

In one embodiment of the assembly method according to the proposed solution, the assembly method for releasably fixing the locking lever in the fixing position may comprise pivoting the locking lever from the neutral position into the fixing position against a pre-tensioning force of a spring element. In this case, the neutral position can be the unlocking position.

Such a spring element can be an elastic element which is connected to the locking lever and another portion of the vehicle seat in such a way that the locking lever is subjected to a pre-tensioning force in such a way that the locking lever can only be deflected from the neutral position against the pre-tensioning force.

In a further embodiment of the proposed assembly method, the unlocking element can be connected to a sliding element, which is displaceably mounted relative to the locking lever, via a fastening part in an assembly position.

The sliding element can be displaceably mounted on a rail of the seat base. Thus, the sliding element can be translationally displaceable on the rail relative to the seat part. In particular, the sliding element can be translationally displaceable on the rail relative to the seat part by moving the seat part from the non-use position to the use position.

In a further embodiment, the fastening part may extend through a slot in the unlocking element and/or the sliding element, wherein the slot allows the unlocking element to be adjusted relative to the sliding element so that a plurality of further mounting positions of the unlocking element can be set.

For example, while the locking lever is temporarily fixed in its fixing position, the connection of the unlocking element to the sliding element can be detached in the assembly position to compensate for manufacturing tolerances, the unlocking element can be moved from the assembly position relative to the locking lever into another assembly position, and the unlocking element can be reconnected to the sliding element in the other assembly position. Thus, the assembly position of the unlocking element can be adjusted relative to the locking lever in such a way that the backrest can be fixed in the use position without play.

By fixing the locking lever, the unlocking element can be load-free. This can facilitate the adjustment of the unlocking element. In particular, by fixing the locking lever, the adjustment can be carried out single-handedly and/or in a single work step and/or faster. This can reduce the assembly costs.

The proposed embodiments for the vehicle seat apply analogously also to the assembly method.

In a further embodiment of the solution, the unlocking element and/or the sliding element may comprise at least one anti-rotation device to block the unlocking element from rotation relative to the fastening part.

By way of example, an anti-rotation device may be formed with a projection on the unlocking element and/or the sliding element, wherein the projection engages in the opening of the respective other of the unlocking element and the sliding element. In a further embodiment, the at least one anti-rotation device can also engage in a further recess in the respective other of the unlocking element and the sliding element.

### BRIEF DESCRIPTION OF THE DRAWINGS

The attached figures illustrate examples of possible design variants of the proposed solution.

FIG. 1A shows a perspective view of a vehicle seat with a seat base, a seat part and a pivotable backrest in a use position.

FIG. 1B a further perspective view of the vehicle seat from FIG. 1A.

FIG. 2 a plan view of a detail of the seat base of the vehicle seat shown in FIG. 1A.

FIG. 3 a side view of the vehicle seat from FIG. 1A.

FIG. 4A a perspective view of a detail of the seat base of the vehicle seat shown in FIG. 1A with the backrest pivoted into a non-use position.

FIG. 4B a perspective view of the detail of the seat base of the vehicle seat shown in FIG. 1A with the backrest pivoted into the use position.

FIG. 4C a detailed view of a locking lever located on the seat base.

FIG. 5A a perspective view of the locking lever arranged on the seat base without backrest and of an unlocking element connected to the seat part.

FIG. 5B the perspective view from FIG. 5A with a detached connection between the seat part and the unlocking element.

FIG. 6 a detailed representation of a further embodiment of the unlocking element with two coupling portions.

FIG. 7A a perspective view of the locking lever in the locking position and of the unlocking element connected to the seat element with two coupling portions.

FIG. 7B the perspective view from FIG. 7A with a detached connection between the seat part and the unlocking element.

### DETAILED DESCRIPTION

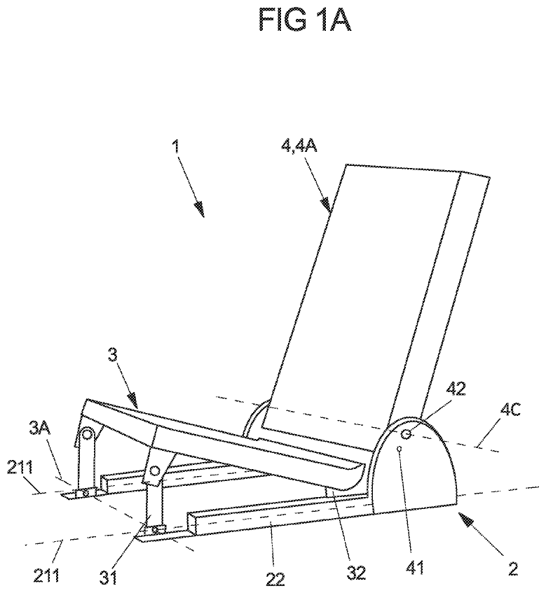

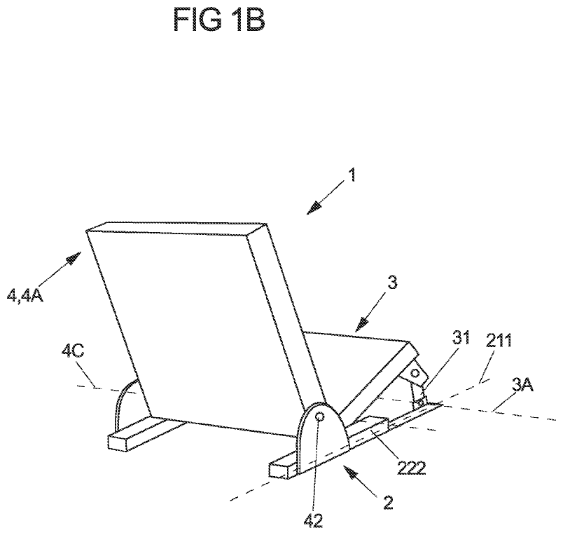

FIG. 1A shows a perspective view of a vehicle seat 1 according to the proposed solution. Such a vehicle seat 1 comprises a seat base 2, a seat part 3 disposed on the seat base 2 and adjustable relative to the seat base 2, and a backrest 4 mounted on the seat base 2 so as to be pivotable between an upright use position 4A and a non-use position 4B pivoted towards the seat part 3. Furthermore, such a vehicle seat also has a coupling mechanism for coupling an adjustment movement of the seat part 3 to a pivot movement of the backrest 4. A locking lever 5 is provided here which can be pivoted between a locking position 5A and a unlocking position 5B by means of the coupling mechanism, is in its locking position 5A in the use position 4A of the backrest 4 and locks the backrest 4 from pivoting into the non-use position 4B, and can be pivoted from its locking position 5A into its unlocking position 5B for pivoting the backrest 4 from the use position 4A into the non-use position 4B.

The non-use position 4B of the backrest 4 serves in particular to reduce the space occupied by the vehicle seat 1 assembled in a vehicle. By contrast, the use position 4A serves in particular to provide a seat surface together with a backrest 4 suitable for leaning against by a vehicle seat user.

In the embodiment shown in FIG. 1A, the backrest 4 is pivotably mounted on the seat base 2 by means of two bearings 42 on both sides of the backrest 4. The bearings 42 define the backrest pivot axis 4C, about which the backrest 4 is pivotable from the illustrated use position 4A into an unillustrated non-use position 4B. The seat base 2 has two guide slots 21, not shown, on both sides for guiding the backrest 4 when pivoting between the use position 4A and the non-use position 4B. Furthermore, a guide element 41 is arranged on both sides of the backrest 4 and is guided along one of the guide slots 21 when the backrest 4 is pivoted from the use position 4A into the non-use position 4B.

The seat base 2 has two rails 22 each with a longitudinal axis of extent 211. The rails 22 are arranged on the seat base 2 with the longitudinal axes 211 orthogonal to the backrest pivot axis 4C. In addition, two seat part levers 31 are pivotably mounted on the rails 22. The pivotable mounting of the seat part levers 31 defines the seat part pivot axis 3A about which the seat part levers 31 are pivotable. Furthermore, the seat part levers 31 are also pivotably mounted on the seat part 3. Thus, in the embodiment of the vehicle seat 1 shown in FIG. 1A, the seat part 3 is pivotably mounted on the seat base 2.

Furthermore, the seat part 3 is adjustable about the seat part pivot axis 3A, which runs parallel to a backrest pivot axis 4C, about which the backrest 4 can be pivoted from the use position 4A into the non-use position 4B. The seat part 3 is also adjustable between a non-use position and a use position. In the use position of the seat part 3 shown in FIG. 1A, the seat part 3 provides a seat surface for the vehicle seat user when assembled as intended.

A sliding element 32 is mounted on each of the rails 22 so as to be translationally displaceable along the longitudinal axis of extent 211 of the rails 22. The two sliding elements 32 are in turn pivotably mounted on the seat part 3. Thus, the seat part 3 is translationally adjustable relative to the seat base 2.

FIG. 1B shows a further perspective view of the vehicle seat 1 from FIG. 1A in a rear view.

In an alternative embodiment deviating from the embodiment shown, the numbers of guide elements 41, rails 22, guide slots 21, locking levers 5, sliding elements 32 and seat part levers 31 can deviate from the numbers shown here. In particular, alternative embodiments can have exactly one guide element 41, one guide slot 21 and one locking lever 5.

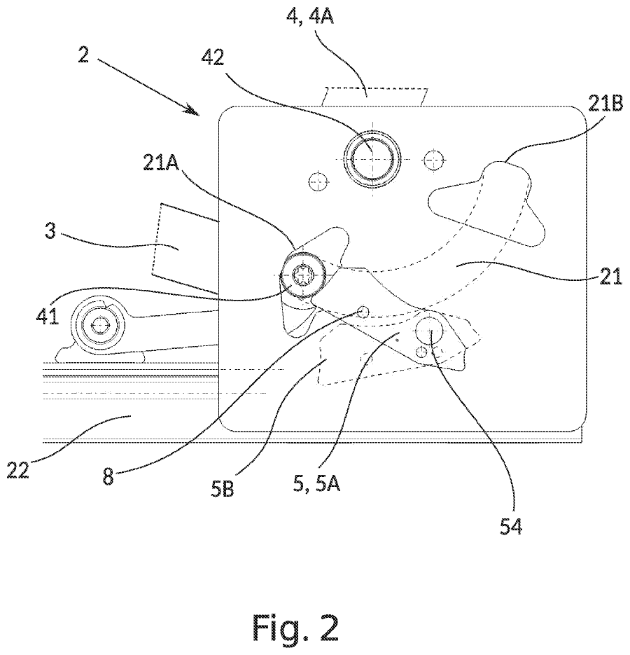

FIG. 2 shows a plan view of a detail of the seat base 2 of the vehicle seat 1 shown in FIG. 1A. According to FIG. 1A, the backrest 4 is pivotably mounted on the seat base 2 via the bearing 42. The backrest 4 is in the use position 4A. The guide element 41 arranged on the backrest 4 engages in the guide slot 21 of the seat base 2. Parts of the guide slot 21 are concealed in the illustration in FIG. 2. In the concealed region, the course of the guide slot 21 is shown by dashed lines.

In the use position 4A of the backrest 4 shown in FIG. 2, the guide element 41 of the backrest 4 rests against a first end portion 21A of the guide slot 21. Furthermore, the guide slot 21 has a second end portion 21B. By pivoting the backrest 4 from the use position 4A into the non-use position 4B, which is not shown, the guide element 41 is pivoted along the guide slot 21 from the first end portion 21A towards the second end portion 21B.

A fixing opening 8 is made in the seat base 2. The fixing opening 8 is aligned here in its fixing position 5C with a fixing opening 8, not shown, of the locking lever 5. By inserting a fixing element into the aligned fixing openings 8, the locking lever 5 can thus be fixed releasably.

In addition, the seat rail 22 is arranged on the seat base 2, on which the sliding element 32 is mounted so as to be translationally displaceable in a manner not shown. The sliding element 32 is connected to the shown seat part 3. The locking lever 5 is mounted on the seat base 2 via the bearing 54 so as to be pivotable between the locking position 5A and the unlocking position 5B. The locking lever 5 rests against the guide element 41 to lock the backrest 4 in the locking position 5A. In the view shown in FIG. 2, the locking lever 5 is concealed by the seat base 2. The guide element 41 is locked via the locking lever 5 with regard to pivoting in the direction of the second end portion 21B of the guide slot 21. Thus, the backrest 4 is also locked against pivoting from the use position 4A into the non-use position 4B.

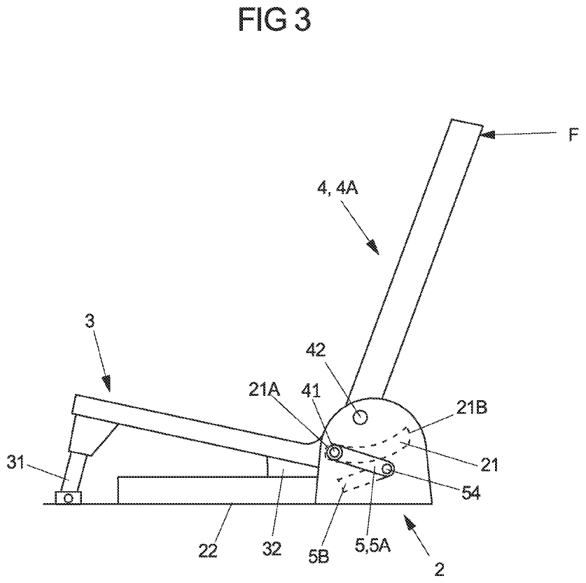

FIG. 3 shows a side view of the vehicle seat 1 from FIG. 1A. As already shown in FIG. 1A, the backrest 4 is pivotably mounted on the seat base 2 via the bearing 42 in the use position 4A. In this case, the backrest 4 has a guide element 41 which is guided in the guide slot 21 of the seat base 2 between the first end portion 21A of the guide slot 21 and a second end portion 21B of the guide slot 21. In the illustrated use position 4A of the backrest 4, the guide element 41 rests against the first end portion 4A of the guide slot 21. In this position, the guide element 41 is fixed in the locking position 5A via the locking lever 5. Pivoting of the backrest 4 is therefore not possible. In particular, pivoting of the backrest 4 is also not possible by a force F introduced into the backrest 4. Thus, by fixing the guide element 41, the backrest 4 is locked against unintentional pivoting due to misalignment forces, such as, for example, persons supporting themselves, slipping loads or the impact of an accident.

As in FIG. 1A, the seat part 3 is also adjustably mounted on the seat base 2. The seat part 3 is pivotably connected to the seat part lever 31. The seat part lever 31 is also pivotably mounted on the rail 22 connected to the seat base 2. An energy storage device, such as a spring element, can be arranged below or above the rail 22 and is connected both to the rail 22 and to the seat part lever 31. The energy storage device then applies a pre-tension to the seat part lever 31 in the direction of the upright position shown.

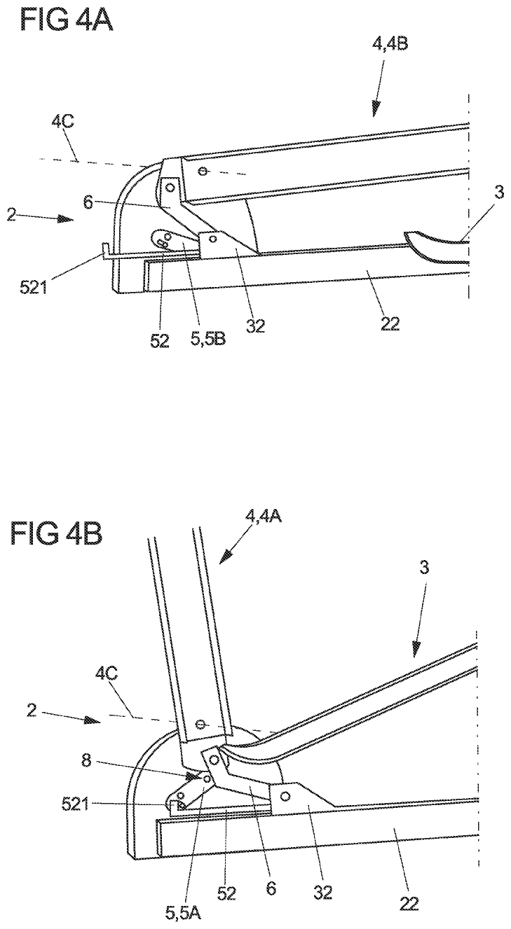

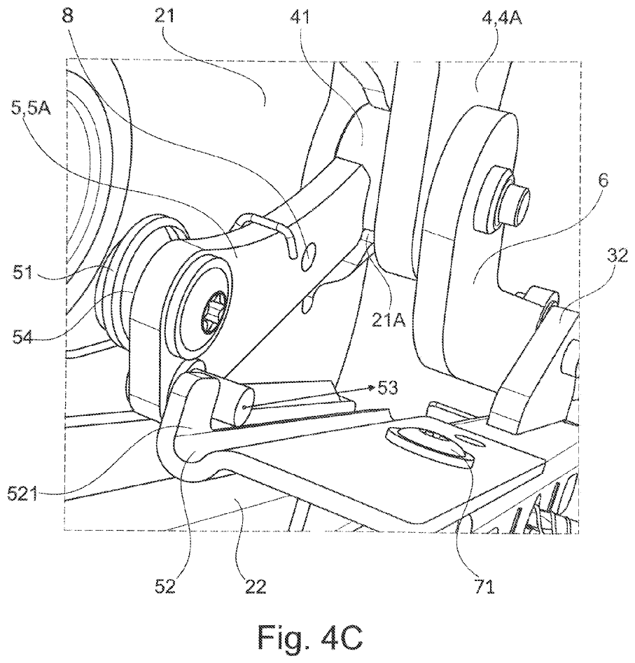

FIG. 4A shows a perspective view of a detail of the seat base 2 of the vehicle seat 1 shown in FIG. 1A in the non-use position 4B of the backrest 4. The backrest 4 is mounted on the seat base 2 via the bearing 42, which is not shown, so as to be pivotable about the backrest 4C. Furthermore, the rail 22 is arranged on the seat part 2, on which the sliding element 32 of the seat part 3 is mounted so as to be translationally displaceable. The unlocking element 52 is connected to the sliding element 32. The unlocking element 52 has a coupling portion 521 here, via which the locking lever 5 can be pivoted from the unlocking position 5B into the locking position 5A. To couple an adjustment movement of the seat part 3 with the pivoting of the backrest 4, the vehicle seat 1 has a coupling element 6 which transfers the adjustment movement of the seat part 3 to the backrest 4. In the embodiment shown in FIG. 4A, the coupling element 6 is pivotably mounted both on the sliding element 32 and on the backrest 3.

FIG. 4B shows a further perspective view of the detail of the seat base 2 of the vehicle seat 1 shown in FIG. 1A. In contrast to the representation in FIG. 4A, the sliding element 32, which is mounted translationally on the rail 22, is displaced relative to the seat base 2. As a result, the seat part 3 connected to the sliding element 32, which is not shown, is transferred into a use position of the seat part 3. The unlocking element 52 connected to the sliding element 32 is also displaced relative to the seat base 2 compared to the position shown in FIG. 4A. By way of the coupling element 6, the relative displacement of the sliding element 32 leads to the pivoting of the backrest 4 about the backrest pivot axis 4C into the use position 4A. Here, the locking lever 5 is pivoted from the unlocking position 5B into the locking position 5A by the coupling portion 521 of the unlocking element 52. Thus, the backrest 4 is locked in the use position 4A from pivoting in the direction of the non-use position 4B.

Furthermore, the locking lever 5 has a fixing opening 8 corresponding to the fixing opening 8 of the seat base 2 for releasably fixing the locking lever 5 in the fixing position.

FIG. 4C shows a detailed representation of the locking lever, which is pivotably mounted on the seat base 2 via a bearing 54, 5 in the locking position 5A. On the locking lever 5 with the fixing opening 8 there is arranged a spring element 51, with which the locking lever 5 is pre-tensioned towards the unlocking position 5A. The locking lever 5 is acted upon by the unlocking element 52, which is displaceably mounted on the seat base 2 via the sliding element 32, with a deflection force 53 against the pre-tension applied by the spring element 51. The sliding element 32 and the unlocking element 52 are detachably connected to the fastening part 71. The guide element 41 is arranged on the backrest 4 in the region of the pivotable mounting of the coupling element 6 with the backrest 4, the guide element resting against the first end portion 21A of the guide slot 21 in the illustrated use position 4A of the backrest.

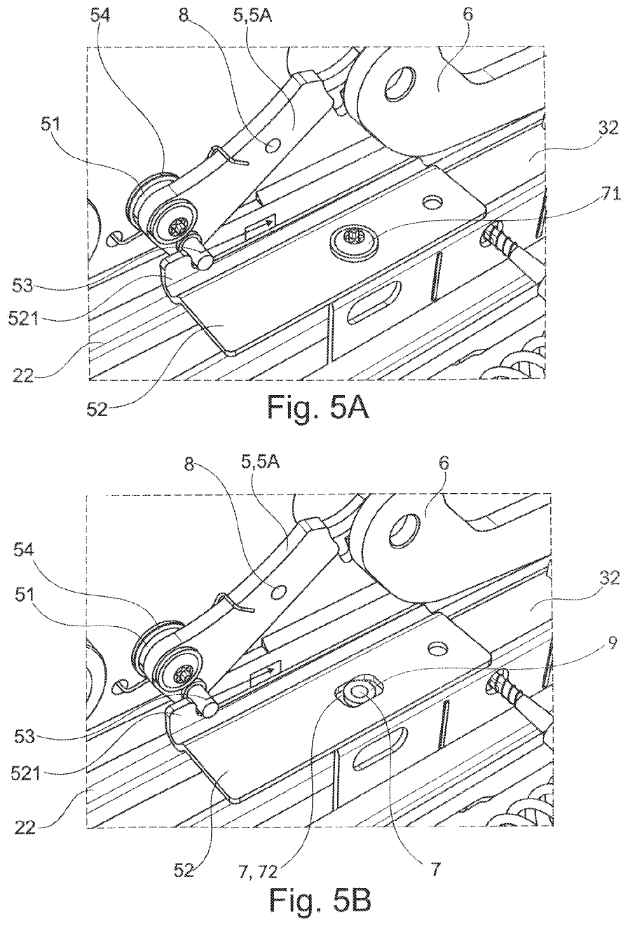

FIG. 5A shows a perspective view of the locking lever 5, which is arranged on the seat base 2 without the backrest 4, and of an unlocking element 52 connected to the sliding element 32. The locking lever 5 has the fixing opening 8, which in the fixing position is aligned with one of the shown fixing openings 8 in the seat base 2. Thus, the locking lever 5 can be fixed with a fixing element in the fixing position via the fixing openings 8.

As in FIG. 4C, in FIG. 5A the coupling portion 521 is in contact with the locking lever 5. The deflection force 53 is introduced into the locking lever 5 via the coupling portion 521 of the unlocking element 52. As a result, the locking lever 5 is pivoted from the unlocking position 5B into the illustrated locking position 5A against the pre-tension applied by the spring element 51. The unlocking element 52 is releasably fixed to the sliding element 32 by means of a fastening part 71 formed as a screw.

FIG. 5B shows the arrangement shown in FIG. 5A, but with the connection between the unlocking element 52 and the sliding element 32 detached. Furthermore, the unlocking element 52 and the sliding element 32 each have an opening 7. The opening 7 in the unlocking element 52 is designed as a slot 72. As a result, the unlocking element 52 can be fixed in various mounting positions on the sliding element 32 for a predetermined position of the sliding element 32 relative to the locking lever 5. By selecting the mounting position, the operative connection of the unlocking element 52 with the locking lever 5 can be adjusted in relation to a displacement of the sliding element 32.

Thus, the assembly position defines at what relative distance of the sliding element 32 to the seat base 2 the shown coupling portion 521 rests against the locking lever 5.

By way of example, the locking lever 5 can be fixed in the fixing position on the seat base 2 via the fixing opening 8 for adjustment. Subsequently, the sliding element 32 can be adjusted to a position relative to the seat base 2 in which the locking lever 5 is intended to lock the backrest 4 in the use position 4A. Subsequently, the connection of the unlocking element 52 to the sliding element 32 can be detached, the unlocking element 52 can be displaced so that the coupling portion 521 abuts the locking lever 5, and further the connection between the unlocking element 52 and the sliding element 32 can be re-established.

In the region of the opening 7, the sliding element 32 has an anti-rotation device 9 in the form of a circumferential edge in order to block the unlocking element 52 against rotation relative to the fastening part 71. For this purpose, the anti-rotation device 9 engages in the slot 72 of the unlocking element 52.

In an alternative embodiment, the anti-rotation device 9 may be formed with a projection on the unlocking element 52 and/or the sliding element 32, wherein the projection engages in the opening 7 of the respective other of the unlocking element 52 and the sliding element 32. In a further embodiment, the anti-rotation device 9 can also engage in a further recess in the respective other of the unlocking element 52 and the sliding element 32.

Furthermore, in the embodiment shown in FIG. 5B, the operative connection between the unlocking element 52 and the locking lever 5 is realized via the coupling portion 521 of the unlocking element 52.

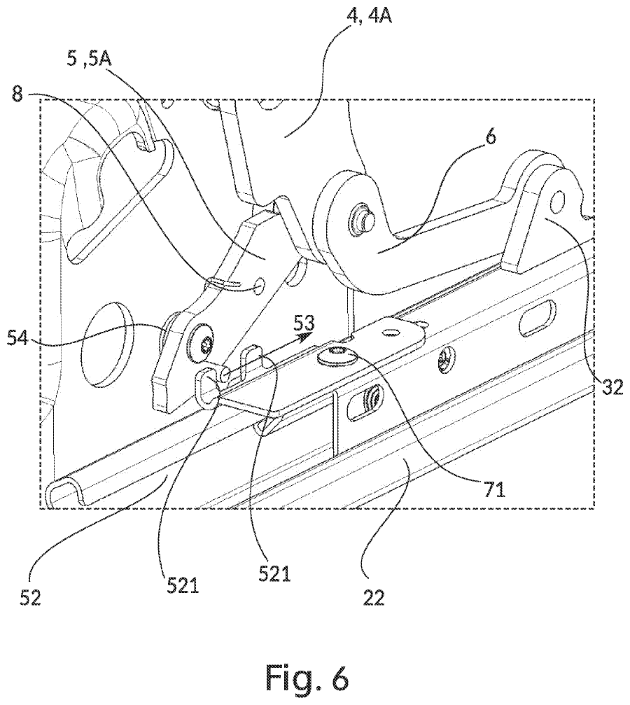

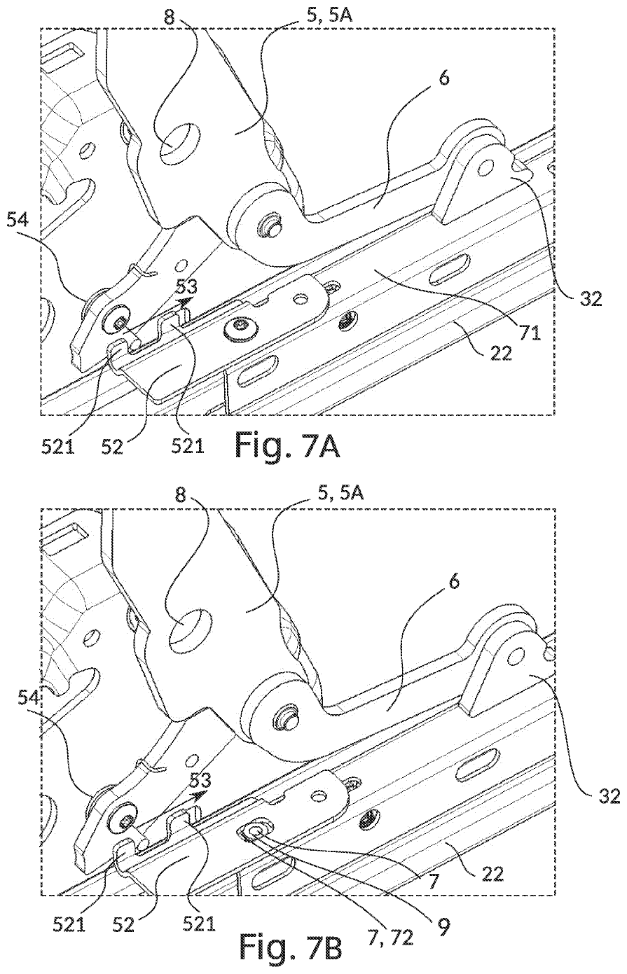

FIGS. 6, 7A and 7B show different perspective views of the unlocking element 52 in an embodiment with two coupling portions 521. Both coupling portions 521 are each formed as a projection on the unlocking element 52 and lie in a plane with the locking lever 5. The two coupling portions 521 extend here starting from the unlocking element 52 in the direction of the locking lever 5. The coupling portions 521 are spaced apart from each other. A pin-shaped portion of the locking lever 5 is arranged between the coupling portions 521. A diameter of the pin-shaped portion is smaller here than a distance between the coupling portions 521, so that there is a play with respect to the pin-shaped portion when the unlocking element 52 is displaced.

In the position of the unlocking element 52 shown in FIGS. 6, 7A and 7B, the two coupling portions 521 shown on the left in the figures are in contact with the pin-shaped portion of the locking lever 5, which is in the locking position 5A. By displacing the unlocking element 52 in a direction opposite the deflection force 53, the left coupling portion 521 can come out of contact with the pin-shaped portion. According to the play, the unlocking element 52 can be displaced in a direction opposite the direction of the deflection force 53 without introducing a force into the locking lever 5 via the coupling portions 521. By displacing the unlocking element 52 beyond the play, the coupling portions 521 shown on the right in the figures comes into contact with the pin-shaped portion of the locking lever 5 and entrains it. Thus, a force opposite the deflection force 53 can be introduced into the locking lever 5 via the right-hand one of the coupling portions 521. This allows the locking lever 5 to be pivoted from the locking position 5A into the unlocking position 5B by displacing the unlocking element 52 against the direction of the deflecting force 53.

Likewise, pivoting the locking lever 5 from the unlocking position 5B into the locking position 5A is possible by moving the unlocking element 52 in the direction of the deflection force 53. Thus, the locking lever 5 can be pivoted back and forth between the unlocking position 5B and the locking position 5A depending on a direction of displacement of the unlocking element 52.

In an embodiment deviating from the embodiment shown, the coupling portions 521 can in principle also be formed with a smaller or larger distance to each other. In particular, the unlocking element 52 can thus also be free of play in relation to the pivoting of the locking lever 5. Optionally, a force can be applied to the locking lever 5 in one of the possible pivot directions.

FIG. 7B shows the arrangement shown in FIG. 7A, but with the connection of the unlocking element 52 to the sliding element 32 detached. The explanations regarding the opening 7, the fastening part 71, the slot 72, the anti-rotation device 9 and the mounting position of the unlocking element 52 in FIG. 5B apply accordingly.

In an alternative embodiment, the unlocking element 52 may be hingedly connected to the locking lever 5. In a further alternative embodiment, both the locking lever 5 and the unlocking element 52 can have toothed portions. The toothed portion of the locking lever 5 can engage in the toothed portion of the unlocking element 521. In addition, other operative connections between the unlocking element 52 and the locking lever 5 are also conceivable in principle, as long as the locking lever 5 can be pivoted from the unlocking position 5B into the locking position 5A by displacing the unlocking element 52 which is operatively connected to the locking lever 5.

### LIST OF REFERENCE SIGNS

1 vehicle seat
F force
2 seat base
21 guide slot
21A first end portion of the guide slot
21B second end portion of the guide slot
22 rail
221 longitudinal axis of extent the rail
3 seat part
3A seat part pivot axle
31 seat part lever
32 sliding element
4 backrest
4A use position
4B non-use positions
4C backrest pivot axis
41 guide element
42 bearing of the backrest
5 locking lever
5A locking position
5B unlocking position
5C fixing position
51 spring element
52 unlocking element
521 coupling portion
53 deflection force
54 bearing of the locking lever
6 coupling element
7 opening
71 fastening part
72 slot
8 fixing opening
9 anti-twist device

1. A vehicle seat, comprising
a seat base,
a seat part which is arranged on the seat base and can be adjusted relative to the seat base,
a backrest which is mounted on the seat base so as to be pivotable between an upright use position and a non-use position which is pivoted towards the seat part,
a coupling mechanism for coupling an adjustment movement of the seat part to a pivot movement of the backrest, and
a locking lever, which can be pivoted between a locking position and an unlocking position by means of the coupling mechanism, is provided, which is in its locking position in the use position of the backrest and locks the backrest from pivoting into the non-use position, and can be pivoted from its locking position into its unlocking position for pivoting the backrest from the use position into the non-use position.

2. The vehicle seat according to claim 1, wherein the coupling mechanism for pivoting the locking lever from the unlocking position into the locking position and/or from the locking position into the unlocking position comprises an unlocking element which is displaceably mounted on the seat base and/or on the backrest and which adjusts the locking lever by way of a displacement.

3. The vehicle seat according to claim 1, wherein the locking lever is mounted on the backrest so as to be pivotable between the locking position and the unlocking position and in the locking position rests against a portion of the seat base.

4. The vehicle seat according to claim 1, wherein the locking lever is pivotably mounted on the seat base between the locking position and the unlocking position and in the locking position rests against a portion of the backrest.

5. The vehicle seat according to claim 1, wherein the vehicle seat has a spring element with which the locking lever is pre-tensioned in the direction of the unlocking position.

6. The vehicle seat according to claim 5, wherein the coupling mechanism for pivoting the locking lever from the unlocking position into the locking position comprises an unlocking element which is displaceably mounted on the seat base and/or on the backrest and which, by way of a displacement, applies a deflecting force to the locking lever against a pre-tension applied by the spring element.

7. The vehicle seat according to any one of the preceding claim 1, wherein the seat base has a guide for guiding the backrest when pivoting between the use position and the non-use position.

8. The vehicle seat according to claim 7, wherein a guide element is arranged on the backrest and is guided along the guide when the backrest is pivoted from the use position into the non-use position (4B).

9. The vehicle seat according to claim 8, wherein the guide element rests against a first end portion of the guide in the use position of the backrest and against a second end portion of the guide in the non-use position of the backrest.

10. The vehicle seat according to claim 8, wherein the locking lever rests against the guide element in the locking position for locking the backrest in the use position.

11. The vehicle seat according to claim 1, wherein the seat part is translationally and/or rotationally adjustable relative to the seat base.

12. The vehicle seat according to claim 1, wherein the coupling mechanism for coupling the adjustment movement of the seat part to the pivoting of the backrest has a coupling element which transfers the adjustment movement of the seat part to the backrest.

13. The vehicle seat according to claim 1, wherein the seat part has a sliding element and the seat base has a rail and the sliding element is displaceably mounted on the rail.

14. (canceled)

15. The vehicle seat according to claim 6, wherein the seat part has a sliding element and the seat base has a rail and the sliding element is displaceably mounted on the rail, wherein the unlocking element is arranged on the sliding element.

16. (canceled)

17. (canceled)

18. An assembly method for a vehicle seat, at least comprising the following steps:
i. providing a seat base with a backrest mounted on the seat base so as to be pivotable between an upright use position and a non-use position, and an adjustable seat part, wherein a coupling mechanism is provided for coupling an adjustment movement of the seat part to a pivot movement of the backrest,
ii. temporarily fixing a locking lever pivotably mounted on the seat base or the backrest in a fixing position,
wherein the locking lever is pivotable between a locking position and an unlocking position in the assembled state of the vehicle seat, and
wherein the locking lever, in its locking position, locks the backrest, which is in an upright use position on the vehicle seat, from pivoting into a non-use position and, for pivoting the backrest from the use position into the non-use position, is pivotable from its locking position into its unlocking position by means of an unlocking element of the coupling mechanism,
iii. mounting the unlocking element relative to the locking lever while the locking lever is temporarily fixed in the fixing position, and
iv. removing the temporary fixing of the locking lever so that the locking lever can be pivoted between its locking position and its unlocking position.

19. The assembly method according to claim 18, wherein the assembly method further comprises, for temporarily fixing the locking lever in the fixing position, pivoting the locking lever from the unlocking position into the fixing position against a pre-tensioning force of a spring element.

20. The assembly method according to claim 18, wherein a releasable fixing element is used for temporarily fixing the locking lever and is removed after assembly of the unlocking element.

21. The assembly method according to claim 18, wherein the locking lever has a fixing opening through which the fixing element is releasably inserted for temporary fixing to the seat base or to the backrest.

22. (canceled)

23. The assembly method according to claim 19, wherein the fastening part extends through a slot in the unlocking element and/or the sliding element, wherein an adjustment of the unlocking element relative to the sliding element is possible through the slot, so that a plurality of further assembly positions of the unlocking element can be set.

24. (canceled)

25. The assembly method according to claim 19, wherein the unlocking element and/or the sliding element comprises an anti-rotation device to prevent rotation of the unlocking element with respect to the fastening part.
